(19) United States
(12) Patent Application Publication
(10) Pub. No.: US 2026/0111989 A1
(43) Pub. Date: Apr. 23, 2026

(54) PERSONALIZED SERVICE STATION RECOMMENDATIONS

(71) Applicant: GM GLOBAL TECHNOLOGY OPERATIONS LLC, DETROIT, MI (US)

(72) Inventors: Ariel Telpaz, Givat Haim Meuhad (IL); Ron Hecht, Raanana (IL); Gershon Celniker, Netanya (IL); Ravid Erez, West Bloomfield, MI (US); Eyal Sandler, Kadima (IL)

(21) Appl. No.: 18/923,030

(22) Filed: Oct. 22, 2024

(51) Int. Cl. G06Q 30/0601

(52) U.S. Cl. CPC G06Q 50/40; G01C 21/3679; G06Q 30/06312; H04W 4/021

(57) ABSTRACT

A system includes a monitoring module configured to determine at least one of a location and a route of a vehicle, and a recommendation module configured to identify a plurality of service stations based on the at least one of the location and the route of the vehicle. The monitoring module is configured to compare a preference of a first user of the vehicle to preference data related to a second user of another vehicle, predict a preferred service station of the plurality of service stations based on the comparing, and present a recommendation to the first user, the recommendation indicating the preferred service station.

### BACKGROUND

The subject disclosure relates to energy or power transfer, and more particularly to systems and methods for controlling power transfer among energy storage systems having different parameters.

Vehicles, including gasoline and diesel powered vehicles, as well as electric and hybrid electric vehicles, feature battery storage for purposes such as powering electric motors, electronics and other vehicle subsystems. Battery assemblies may be charged using dedicated charging stations and other power sources such as residences and buildings connected to a power grid. When a vehicle is travelling, there may be multiple charging stations available. It is desirable to provide a device or system that can determine a most preferred or optimal charging station for the vehicle.

### SUMMARY

In one exemplary embodiment, a system includes a monitoring module configured to determine at least one of a location and a route of a vehicle, and a recommendation module configured to identify a plurality of service stations based on the at least one of the location and the route of the vehicle. The monitoring module is configured to compare a preference of a first user of the vehicle to preference data related to a second user of another vehicle, predict a preferred service station of the plurality of service stations based on the comparing, and present a recommendation to the first user, the recommendation indicating the preferred service station.

In addition to one or more of the features described herein, the vehicle is an electric vehicle and the plurality of service stations are a plurality of charging stations.

In addition to one or more of the features described herein, the first user and the second user are part of a plurality of users, and the second user is selected from the plurality of users based on a similarity between the second user and the first user.

In addition to one or more of the features described herein, the similarity is determined based on comparing an attribute of the first user to an attribute of each of the plurality of users.

In addition to one or more of the features described herein, predicting the preferred service station includes assigning a predicted score to at least one of the plurality of service stations.

In addition to one or more of the features described herein, the predicted score is determined based on a score matrix for a plurality of users, the plurality of users including the first user and the second user, the score matrix including a score for each combination of a user and an identified service station.

In addition to one or more of the features described herein, the similarity is determined based on a first set of latent factors for each user of the plurality of users, and a second set of latent factors for the plurality of service stations, the first set of latent factors and the second set of latent factors estimated based on a machine learning algorithm.

In addition to one or more of the features described herein, predicting the preferred service station includes training the machine learning algorithm, generating a user latent factor vector for each user of the plurality of users, generating a service station latent factor vector for each service station of the plurality of service stations, and combining the user latent factor vectors and the service station latent factor vectors.

In addition to one or more of the features described herein, predicting the preferred service station includes selecting the second user based on the combining, and assigning a predicted score to the first user based on a score of the second user.

In another exemplary embodiment, a method includes determining at least one of a location and a route of a vehicle, identifying a plurality of service stations based on the at least one of the location and the route of the vehicle, comparing a preference of a first user of the vehicle to preference data related to a second user of another vehicle, predicting a preferred service station of the plurality of service stations based on the comparing, and presenting a recommendation to the first user, the recommendation indicating the preferred service station.

In addition to one or more of the features described herein, the vehicle is an electric vehicle and the plurality of service stations are a plurality of charging stations.

In addition to one or more of the features described herein, the first user and the second user are part of a plurality of users, and the second user is selected from the plurality of users based on a similarity between the second user and the first user.

In addition to one or more of the features described herein, predicting the preferred service station includes assigning a predicted score to at least one of the plurality of service stations.

In addition to one or more of the features described herein, the similarity is determined based on a score matrix for a plurality of users, the plurality of users including the first user and the plurality of second users, the score matrix including a score for each combination of a user and an identified service station.

In addition to one or more of the features described herein, the similarity is determined based on a first set of latent factors for each user of the plurality of users, and a second set of latent factors for the plurality of service stations, the first set of latent factors and the second set of latent factors estimated based on a machine learning algorithm.

In addition to one or more of the features described herein, predicting the preferred service station includes training the machine learning algorithm, generating a user latent factor vector for each user of the plurality of users, generating a service station latent factor vector for each service station of the plurality of service stations, and combining the user latent factor vectors and the service station latent factor vectors.

In addition to one or more of the features described herein, predicting the preferred service station includes selecting the second user based on the combining, and assigning a predicted score to the first user based on a score of the selected second user.

In yet another exemplary embodiment, a vehicle system includes a memory having computer readable instructions, and a processing device for executing the computer readable instructions, the computer readable instructions controlling the processing device to perform a method. The method includes determining at least one of a location and a route of a vehicle, identifying a plurality of service stations based on the at least one of the location and the route of the vehicle, comparing a preference of a first user of the vehicle to preference data related to a second user of another vehicle, where the first user and the second user are part of a plurality of users. The method also includes predicting a preferred service station of the plurality of service stations based on the comparing, and presenting a recommendation to the first user, the recommendation indicating the preferred service station.

In addition to one or more of the features described herein, the second user is selected from the plurality of users based on a similarity between the second user and the first user.

In addition to one or more of the features described herein, the similarity is determined based on a score matrix for the plurality of users, the score matrix including a score for each combination of a user and an identified service station, and the similarity is determined based on a first set of latent factors for each user of the plurality of users, and a second set of latent factors for the plurality of service stations, the first set of latent factors and the second set of latent factors estimated based on a machine learning algorithm.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a top schematic view of a motor vehicle including a battery system, in accordance with an exemplary embodiment;

FIG. 2 schematically depicts a number of vehicle users and charging stations, and illustrates aspects of a method of predicting a user preference and presenting a service station recommendation, in accordance with an exemplary embodiment;

FIG. 3 is a flow diagram depicting aspects of a method of recommending a service station to a vehicle user, in accordance with an exemplary embodiment;

FIG. 4 depicts aspects of determining a service station recommendation based on a score matrix and a collaborative filtering technique, in accordance with an exemplary embodiment;

FIG. 5 depicts aspects of determining a service station recommendation based latent factors learned via a machine learning model, in accordance with an exemplary embodiment;

FIG. 6 depicts aspects of determining a service station recommendation based latent factors learned via a machine learning model, in accordance with an exemplary embodiment;

FIG. 7 depicts an example of a score matrix, in accordance with an exemplary embodiment;

FIG. 8 depicts an example of a custom filter, in accordance with an exemplary embodiment;

FIG. 9 depicts an example of a multi-dimensional embedding that includes clusters associated with users having similar preferences, in accordance with an exemplary embodiment; and

FIG. 10 depicts a computer system in accordance with an exemplary embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features.

In accordance with one or more exemplary embodiments, methods, devices and systems are provided for presenting recommendations to a user regarding available charging stations or other service stations (e.g., gas stations and/or diesel stations for combustion and hybrid vehicle, hydrogen stations for fuel cell vehicles, etc.). An embodiment of a recommendation system is configured to provide personalized recommendations to a user of a vehicle based on user preferences, vehicle type and behaviors. The recommendation may be based on a score assigned to each charging/fueling station for the user.

In an embodiment, the score assigned to a charging station for a user (also referred to as a “first user”) is estimated based on determining preferences and other information for a plurality of other users (also referred to as “second users”), and determining a similarity between the first user and each of the plurality of second users. The similarity may be determined by a collaborative filtering technique that employs matrix factorization to identify latent factors associated with each user and charging station. The latent factor(s) and/or other information associated with the other users are compared to identify another user or users having the greatest similarity. A score is assigned to one or more charging stations (e.g., charging station(s) that do not already have an assigned score) based on an existing score assigned to the one or more charging stations by a similar user. Scores associated with each charging station may then be used to recommend a most optimal or desired charging station for the user.

Embodiments described herein present numerous advantages and technical effects. For example, the embodiments provide for improvements in navigation, user experience, charging and vehicle performance by providing personalized recommendations for charging stations that a user will find most beneficial. Embodiments provide benefits such as reduced or minimized travel time and/or charging time, increased user satisfaction and others. Embodiments allow the user to employ a charging station that is most conducive to the user's behavior, route and preferences, thereby saving time and ensuring that the most suitable charging station is used.

Existing recommendation systems recommend public charging locations along a driving route; however, recommendations from such systems are solely based on distance from the route's path. Embodiments described herein customize recommendations for specific users based on their preferences and behaviors, which optimizes user satisfaction and public charging experience. In addition, user preferences and scores for a given charging station can be inferred without the need to directly query the user.

The embodiments are not limited to use with any specific vehicle or device or system that utilizes battery assemblies, and may be applicable to various contexts. For example, embodiments may be used with automobiles, trucks, aircraft, construction equipment, farm equipment, automated factory equipment and/or any other device or system that may use charging stations.

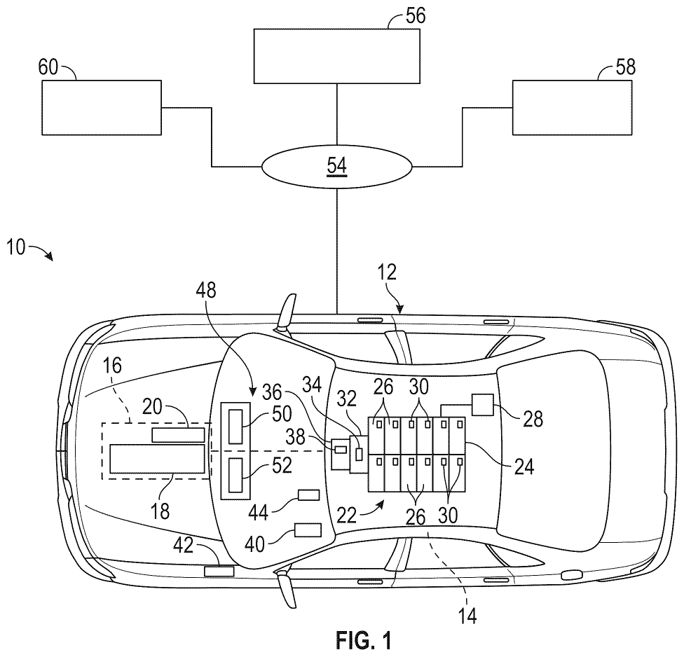

FIG. 1 shows an embodiment of a motor vehicle 10, which includes a vehicle body 12 defining, at least in part, an occupant compartment 14. The vehicle body 12 also supports various vehicle subsystems including a propulsion system 16, and other subsystems to support functions of the propulsion system 16 and other vehicle components, such as a braking subsystem, a suspension system, a steering subsystem, a fuel injection subsystem, an exhaust subsystem and others.

The vehicle 10 may be a combustion engine vehicle, an electrically powered vehicle (EV) or a hybrid electric vehicle (HEV). In an example, the vehicle 10 is a hybrid vehicle that includes a combustion engine 18 and an electric motor 20.

The vehicle 10 includes a battery system 22, which may be electrically connected to the motor 20 and/or other components, such as vehicle electronics. In an embodiment, the battery system 22 includes a battery assembly such as a high voltage battery pack 24 having a plurality of battery modules 26. Each of the battery modules 26 includes a number of individual cells (not shown). The battery system 22 may also include a monitoring unit 28 configured to receive measurements from sensors 30. Each sensor 30 may be an assembly or system having one or more sensors for measuring various battery and environmental parameters, such as temperature, current and voltages. The monitoring unit 28 includes components such as a processor, memory, an interface, a bus and/or other suitable components.

The battery system 22 includes various conversion devices for controlling the supply of power from the battery pack 24 to the motor 20 and/or electronic components. The conversion devices include a direct current (DC)-DC converter module 32 including a DC-DC converter 34. The conversion devices also include an inverter module 36 that includes an inverter 38, which receives DC power from the DC-DC converter 34 and converts DC power to alternating current (AC) power that is supplied to the electric motor 20.

The vehicle 10 also includes a charging system, which can be used to charge the battery system 22 and/or to supply power from the battery system 22 to charge another energy storage system (e.g., vehicle-to-vehicle (V2V) and/or vehicle-to-everything (V2X) charging). The vehicle charging system includes a charging control device 40, such as an onboard charging module (OBCM) connected to a charge port 42.

The charging control device 40 may be configured to perform other functions, such as monitoring battery parameters (e.g., temperature, voltage, current and impedance) during a charging process, controlling aspects of a charging process and/or providing charging station recommendations as described herein.

The vehicle 10 includes at least one processor or processing device for controlling aspects of identifying and recommending charging stations, referred to as a processor 44. The processor 44 may be a separate device as shown, or part of the vehicle's monitoring and/or navigation systems. It is noted that embodiments are not limited to any specific controller or processing device, and may encompass multiple processors or control devices.

The vehicle 10 also includes a computer system 48 that includes one or more processing devices 50 and a user interface 52. The computer system 48 may communicate with a controller or vehicle system, for example, to provide commands thereto in response to a user input. The various processing devices, modules and units may communicate with one another via a communication device or system, such as a controller area network (CAN) or transmission control protocol (TCP) bus.

The processor 44, the computer system 48 and/or other processing components in the vehicle 10 may be configured to communicate with various remote devices and systems such as charge stations and other vehicles. Such communication can be realized, for example, via a network 54 (e.g., cellular network, cloud, etc.) and/or via wireless communication. For example, the vehicle 10 may communicate with various charging stations 56, a remote entity 58 (e.g., a workstation, fleet management system, a computer, a server, a mapping system, etc.), and/or a database 60. The database 60 may store information regarding charging station locations and parameters (e.g., legacy or DC fast charging), as well as user information. The database 60 may store a score matrix described further herein.

Embodiments include one or more methods for identifying and recommending one or more charging stations for a user. Generally, the method includes identifying potential charging stations that could be used by the user, based on the user's route and/or location. The method also includes providing a recommendation to a user based on scores or preferences of one or more other users having a sufficient similarity to the user.

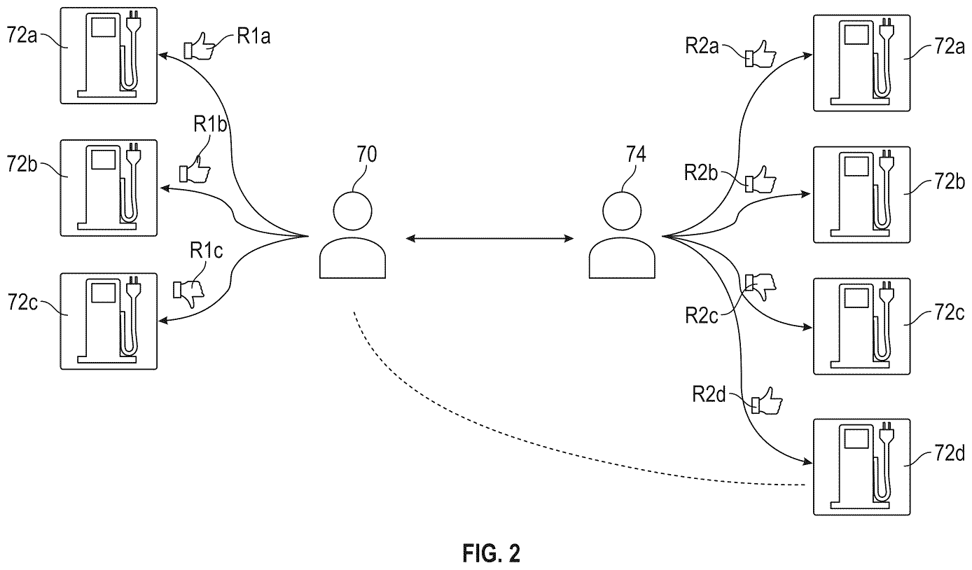

FIG. 2 schematically depicts a number of vehicle users and charging stations, and illustrates aspects of an example of a recommendation method described herein. In this example, a first user 70 is driving an electric vehicle, and it is determined that the vehicle 10 should visit a charging station. Based on the vehicle's location and/or route, four charging stations 72a, 72b, 72c and 72d are considered to be available (e.g., within a selected distance from the vehicle 10 and/or a location along a route).

The recommendation method includes identifying one or more similar users. A “similar” user refers to another user of another vehicle, where the another user and/or the another vehicle has at least one attribute shared in common (or at least one attribute that is sufficiently similar). In this example, user information such as vehicle type and demographics is used to identify a similar user, referred to as a second user 74.

A processing device accesses charging station and user data (e.g., in the database 60), which includes information regarding the first user 70 and the second user 74 (and potentially one or more additional users/drivers). The charging station and user data also includes information regarding the available charging stations.

The second user 74 is associated with a score or ranking for each charging station 72a, 72b, 72c and 72d. It is noted that a score or ranking is specific to a given user and a specific charging station.

For example, charging station scores for the second user 74 include a score R2a associated with the charging station 72a, a score R2b associated with the charging station 72b, a score R2c associated with the charging station 72c, and a score R2d associated with the charging station 72d. Each score in this example is indicated by a “thumbs up” symbol representing a positive score (or relatively high score), or a “thumbs down” symbol representing a negative score (or relatively low score).

The first user 70 is associated with scores for each of the charging stations 72a, 72b, 72c, but does not have a score for the charging station 72d. For example, charging station scores for the first user 70 include a score R1a associated with the charging station 72a, a score R1b associated with the charging station 72b, and a score R1c associated with the charging station 72c.

The method includes predicting a score that would be assigned by the first user 70, based on preferences of the second user 74. The method then includes assigning a first user score (thumbs up) for the charging station 72d that is the same as the score for the charging station 72d that is associated with the second user 74 (thumbs up). Now that all of the charging stations have scores associated with the user 70, a recommendation may be presented to the user 70.

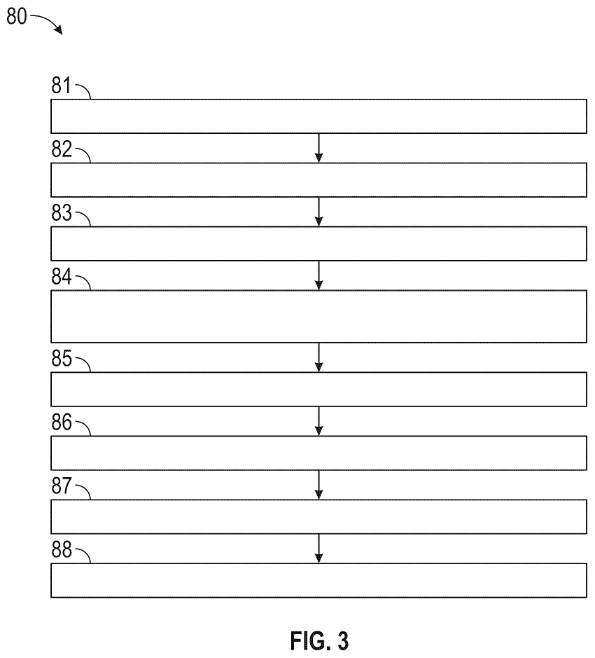

FIG. 3 depicts an embodiment of a method 80 of recommending a charging station, or other service station or location, to a user. The method 80 includes a number of steps or stages represented by blocks 81-88. The method 80 is not limited to the number or order of steps therein, as some steps represented by blocks 81-88 may be performed in a different order than that described below, or fewer than all of the steps may be performed.

The method 80 is described in conjunction with the vehicle 10 and the processor 44 for illustration purposes. It is understood that the method 80 may be performed using any type of vehicle and any suitable processing device or combination of processing devices.

Although embodiments are described in conjunction with electric vehicles and charging stations, the embodiments are not so limited. For example, embodiments may apply to combustion vehicles and hybrid vehicles, and other types of service stations (e.g., gas stations, mechanics, dealerships, etc.).

At block 81, the processor 44 determines that it is desired for the vehicle 10 to visit a public charging station. The processor 44 may make this determination based on a user request, or signal indicating that the battery system has a low charge. A driver or user of the vehicle 10 is referred to herein as the “first user.”

At block 82, the processor 44 collects or accesses information describing characteristics of the first user and the vehicle 10. The information may include user preferences (e.g., the charging station should be near a restaurant or other place of interest), user demographics (e.g., age), any limitations of the first user (e.g., mobility issues that may affect the type of charging station that the first user can comfortably use), and any other information relevant to determining similarities between the first user and other users. This information may also include vehicle type and charging capabilities.

At block 83, the processor 44 identifies available charging stations that are within a selected distance of the vehicle 10, and/or are conveniently accessible from a planned route.

At block 84, the processor 44 accesses user data for one or more other users (second users) that have used the available charging stations and/or have provided ranking or other preference information regarding the available charging stations. User data for the other users may include scores or preferences associated with the charging stations for each other user, and demographic information.

At block 85, the user data is compared to the information related to the first user, and the processor 44 determines a level of similarity between the first user and each of the other users. The level of similarity may be determined, at least in part, by finding matching or similar characteristics between users. Examples of such characteristics include age (and/or other demographic characteristics), preferences, vehicle type, charging capabilities and others.

In an embodiment, the level of similarity is determined at least partially by estimating latent factors for each user (the first user and the other users). A “latent factor” is any feature or attribute of a user that is determined by machine learning, as discussed further herein. Latent factors can be discovered without the need to query or prompt the user of the vehicle 10, allowing for similarity determination without the need for input from the user.

At block 86, the processor 44 identifies which other user or group of users has/have the greatest similarity (the “similar user” or “similar users”), and assigns a predicted score to each available charging station for the first user (or each available charging station that does not have a pre-defined score for the first user). The predicted score is based on scores or preferences of the similar user or users.

If a score is pre-defined or already assigned to one or more charging stations (for the first user), the scores for the similar user or users are used to predict scores and assign a predicted score to each of the remaining charging stations. If multiple similar users have assigned different scores to a charging station, the predicted score may be based on an average of the scores or other value based on the scores.

At block 87, the processor 44 identifies which charging station has the highest score (a pre-defined score or a predicted score), or which group of charging stations has the highest scores, and presents a recommendation as to which charging station is most preferred to the first user. The recommendation may be presented as a single charging station, or multiple charging stations that meet the preferences of the first user. For example, a list of charging stations may be presented graphically or textually, along with respective rankings or scores (e.g., numerical rankings, colors, thumbs up/down symbols or other symbols, etc.). A recommendation may be presented via any suitable modality (e.g., graphically via a touchscreen or heads up display, audibly, etc.).

The predicted score and recommendation of charging stations may account for additional factors, beyond factors or information used in determining similarity. For example, the machine learning model can also account for predicted availability given a planned route, distance from planned route, reliability issues and other charging related aspects. This can be achieved with a weighted score formula.

At block 88, various actions may be performed based on the recommendation. For example, directions to a recommended charging station may be provided, or if the vehicle 10 has autonomous control capability, the vehicle 10 may be controlled autonomously to go to the recommended charging station. In another example, the vehicle 10 may communicate with a network and/or the recommended charging station.

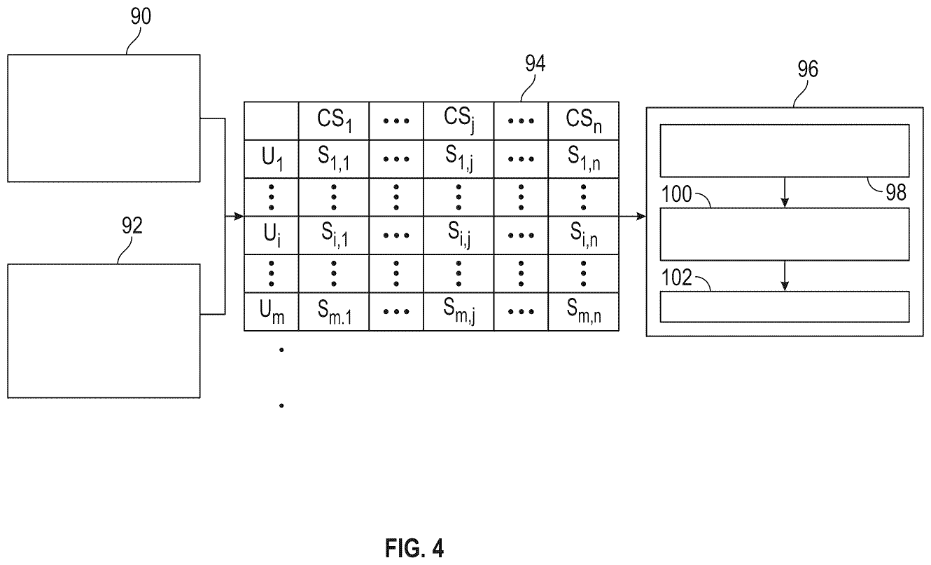

FIG. 4 schematically depicts an embodiment of the method 80 of FIG. 3, in which similarity determinations are based on factorization of a matrix of user scores. Similarities are determined using collaborative filtering, in which matrix factorization is used to learn latent factors. The latent factors are used to identify which other user(s) is/are similar to a first user. A score assigned to a charging station for a similar user may then be used to predict a score and assign the predicted score to the charging station for the first user.

Referring to FIG. 4, charging station data 90 and user data 92 is accessed, and used to construct or update a user-station matrix 94 of user ratings or scores for a plurality of users (including the first user of the vehicle 10) and charging stations. The matrix 94 is referred to as a “score matrix.”

The charging station data 90 includes various types of information for each of a plurality of charging stations. Examples include an identifier (e.g., a numerical ID) and a location (e.g., from GPS communications) of each charging station. The charging station data 90 may include other characteristics of each charging station, such as charging level (e.g., DC fast charging (DCFC)), autocharging capability, plug type and others.

The user data 92 includes various types of information for each of a plurality of users, which can be used to determine similarities between users and user preferences. Examples include an identifier (e.g., a numerical identifier) and a demographic information for each user.

The user data 92 may also include information regarding users' experiences with and ratings of various charging stations. Such information may include actual user ratings, number of visits to a given charging station with successful charging sessions, number of visits with unsuccessful attempts, charging speed and others.

User and charging station data are used to construct the score matrix 94. For each user, a score is calculated for each charging station (if enough information is available to make the calculation).

In FIG. 4, the score matrix 94 includes a row for m users (U₁ . . . Uᵢ . . . Uₘ), and a column for n charging stations (CS₁ . . . CSⱼ . . . CSₙ). The score matrix is populated with a score (e.g., 1-5) in one or more entries where the preference or ranking is given or calculated. The score may be taken directly from a known ranking, or inferred based on other information. For example, a score may be based on a number of successful charging attempts by a user at a given charging station, a number of kilowatt-hours charged at a session and/or a charging speed. A number of entries may be empty, where the preference or ranking of a charging station with respect to a given user is unknown.

The processor 44 uses a collaborative filtering technique (represented by element 96), which may include initially finding similar characteristics between users and vehicles (represented by element 98), and similarities between charging stations. These relations may be used to identify a user or users that are most similar to the first user, and identify similar charging stations.

The processor 44 collects data for a plurality of users and charging stations from the score matrix 94. Collection may be performed for all of the users and charging stations, or a subset based on the similar characteristics. For example, if prediction and recommendation is being performed for User₁, data is collected for a group of other users having a sufficient level of similarity.

In an embodiment, the collaborative filtering 96 includes learning latent factors of the collected users and charging stations (element 100). The latent factors are learned through machine learning techniques as discussed further herein. The semantic relations and/or latent factors are then used to predict scores for U₁ (represented by element 102).

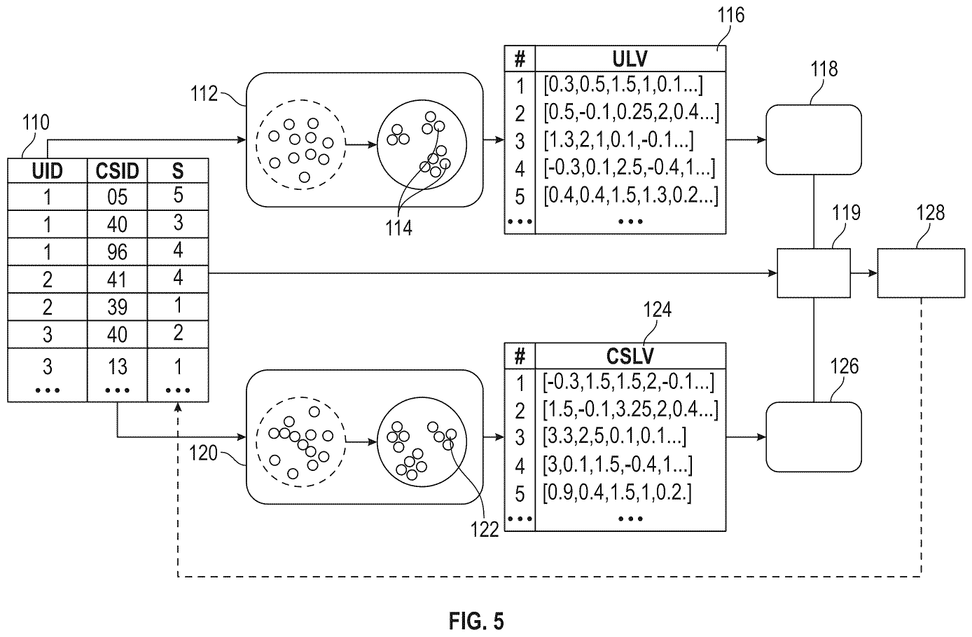

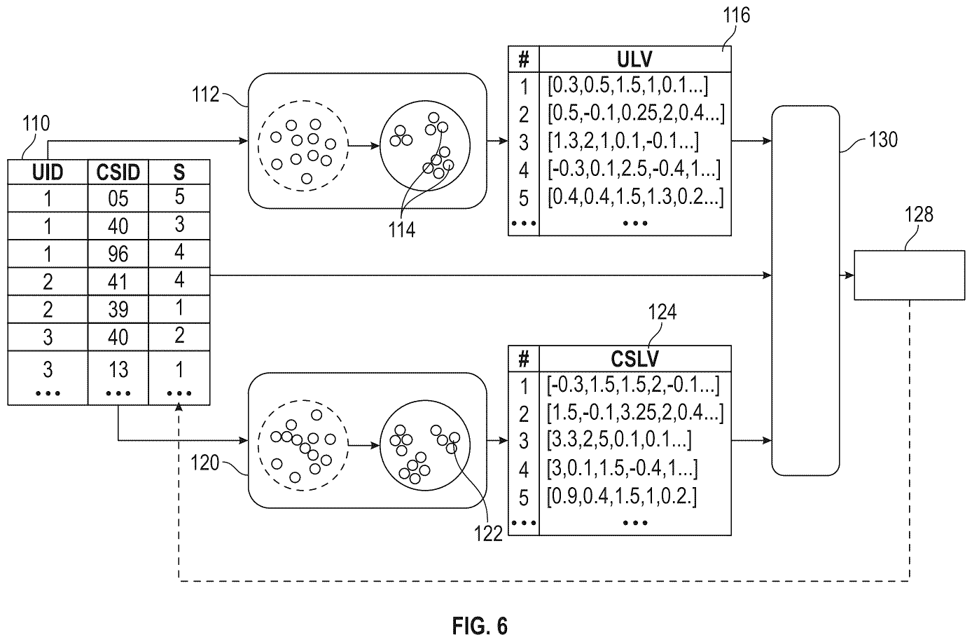

FIGS. 5 and 6 schematically depict aspects of embodiments of the method 80. In these embodiments, a neural network or other machine learning model is trained to detect latent factors of the users and the charging stations, which are used to determine similarities and predict scores.

In this embodiment, user and charging station score data 110 from the score matrix 94 (e.g., a list of user and charging station identifiers, scores or combinations thereof) are input to a latent feature space or embedding space (embedding). For example, the user and charging station data 110 includes a user identifier (UID) column, and a charging station identifier (CSID) column. A score(S) column includes a numerical score for each combination of a user and a charging station.

In an embodiment, user data describing characteristics of each user is input to an embedding layer 112. The embedding layer 112 is trained to generate clusters 114 of similar users. The clusters provide a set of user latent vectors (ULV) 116 for each user identifier,

Similarly, charging station data describing characteristics of each available charging station is input to an embedding layer 120 that is trained to generate clusters 122 of similar charging stations. The clusters provide a set of latent vectors (SCLV) 124 for each charging station identifier.

In an embodiment, shown in FIG. 5, the latent vectors 116 are combined into a dense layer 118, and the latent vectors 124 are combined into a dense layer 126. The dense layers 118 and 126 are combined by calculating a cross product of the dense layers (represented by element 119). The result is a set of predicted scores 128 for each combination of user and charging station. Losses (differences between predicted and actual scores) may be returned to refine the score predictions.

FIG. 6 represents an alternative to the embodiment of FIG. 5. In this embodiment, the matrix information and the latent vectors are applied to another machine learning model 130, which learns the dot product via a deep neural network.

The training process for predicting scores may be repeated as desired. For example, training may be repeated over pre-determined time intervals (e.g., daily, weekly, etc.).

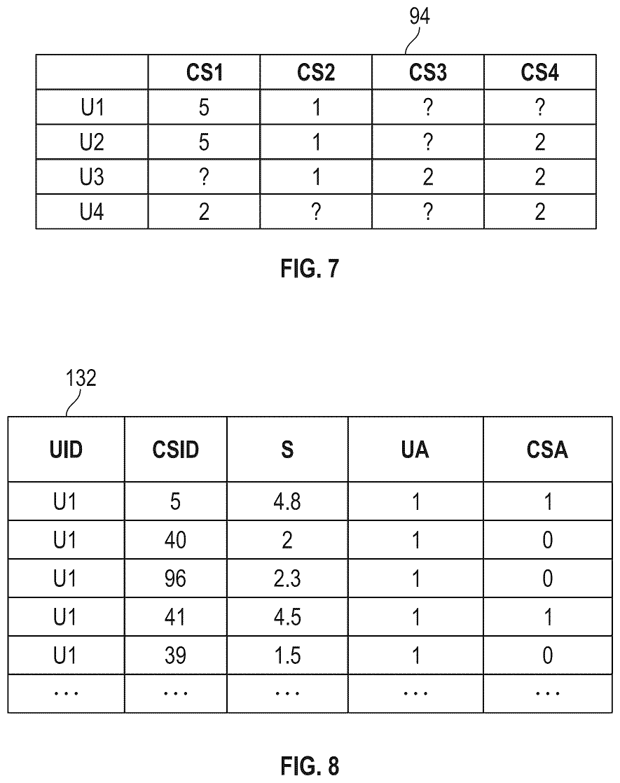

FIG. 7 depicts an example of the score matrix 94, and examples of pre-existing or pre-defined scores. In this example, the score matrix represents four users (U₁ through U₄) and four charging stations (CS₁ through CS₄). In this example, there are scores missing (represented by “?”), which can be predicted based on similarities between users. By applying this data to the machine learning model including the embedding layers 112 and 120, a missing score can be added based on a score of a similar driver. For example, if U₁ is determined to be similar to U₃ (i.e., they have similar preferences), a score of “2” can be assigned for the combination of U₁ and CS₄.

In an embodiment, custom filters may be added to the method 80, in order to account for specific requirements or characteristics, or to further analyze the similarity between users and charging stations. A custom filter procedure may be performed to provide for additional filtering. The procedure includes selecting or creating a category, such as plug type or whether a charging mode such as autocharge is available.

The custom filter procedure includes creating a vector representation that is a concatenation of two types of vectors. A first vector is a learned embedding, denoted as “e”. The norm of these vectors are significantly lower than one (∥e∥=ε<<1).

A second vector (scalar) represents a desired category “c”, which serves as an indicator function and has a value of one or zero.

The concatenated vector is denoted as x. For a given user having an embedding x₁ and a given charging station having an embedding x₂, the concatenated vector is represented by:

$${x}_{2}^{T} {x}_{1} = {x}_{1} \cdot {x}_{2} = {e}_{1} \cdot {e}_{2} + {c}_{1} \cdot {c}_{2} .$$

When x₁ and x₂ share the same category, the concatenated vector is represented by:

$${x}_{2}^{T} {x}_{1} = {x}_{1} \cdot {x}_{2} = {e}_{1} \cdot {e}_{2} + {c}_{1} \cdot {c}_{2} = ‖ {e}_{1} ‖ ‖ {e}_{2} ‖ cos θ + 1 \approx ε + 1 .$$

When x₁ and x₂ do not share the same category, the concatenated vector is represented by:

$${x}_{2}^{T} {x}_{1} = {x}_{1} \cdot {x}_{2} = {e}_{1} \cdot {e}_{2} + {c}_{1} \cdot {c}_{2} = ‖ {e}_{1} ‖ ‖ {e}_{2} ‖ cos θ + 0 \approx ε .$$

Adding the indicator function causes vectors in the same categories to have significantly higher dot products.

FIG. 8 depicts an example of user score information 132 for the user U₁, which includes a predicted score S assigned to each of a group of charging stations, and also includes an indicator function for each of two categories. A first category (denoted by UA) is whether the user' vehicle has autocharge capability. An indicator function value of one is provided if the user's vehicle has autocharge capability, and a value of zero is provided if the user's vehicle does not have this capability. A second category (denoted by CSA) is whether a charging station has autocharge capability. An indicator function value of one is provided if the charging station has autocharge capability, and a value of zero is provided if the charging station does not have such a capability.

FIG. 8 also shows the category value for the user U₁ and each charging station. As shown, using an indicator function results in a higher dot product and correspondingly higher score. For example, scores associated with a user and charging station in the same category have significantly higher scores (4.8 and 4.5) than scores for charging stations that are in a different category than the user (2, 2.3 and 1.5).

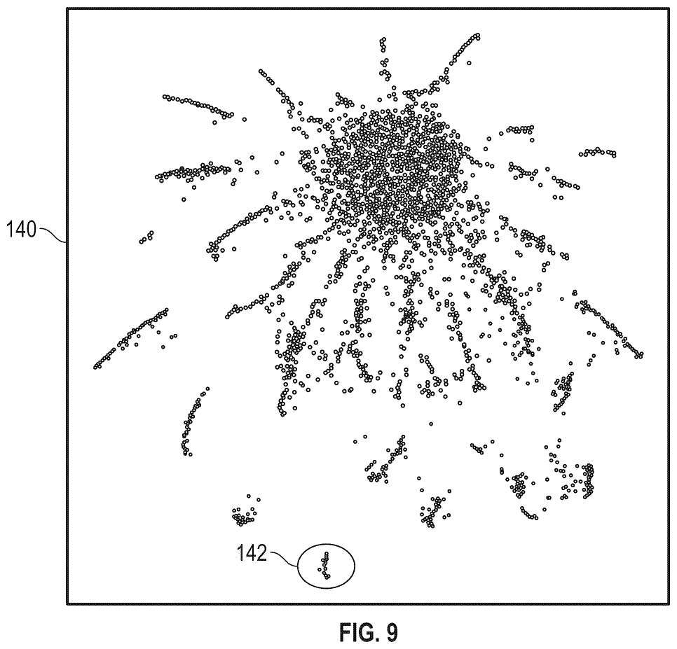

It is noted that the embedding layers may be two dimensional, three-dimensional, or have any number of dimensions. FIG. 9 shows an example of a 15-dimension user embedding layer 140, which represents a plurality of users. The embedding layer includes various clusters, such as a cluster 142, which represent users that are predicted to have similar preferences (i.e., similar users).

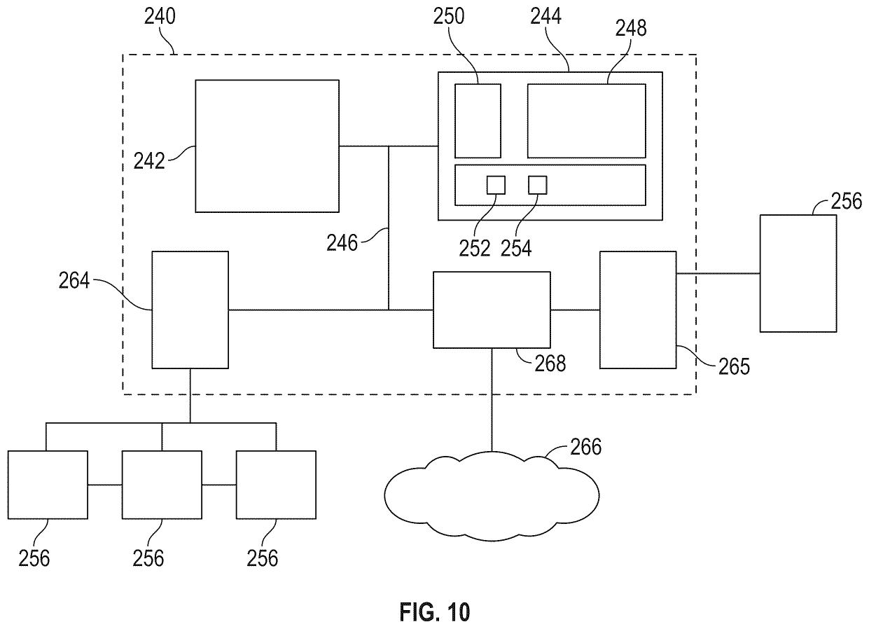

FIG. 10 illustrates aspects of an embodiment of a computer system 240 that can perform various aspects of embodiments described herein. The computer system 240 includes at least one processing device 242, which generally includes one or more processors for performing aspects of image acquisition and analysis methods described herein.

Components of the computer system 240 include the processing device 242 (such as one or more processors or processing units), a memory 244, and a bus 246 that couples various system components including the system memory 244 to the processing device 242. The system memory 244 can be a non-transitory computer-readable medium, and may include a variety of computer system readable media. Such media can be any available media that is accessible by the processing device 242, and includes both volatile and non-volatile media, and removable and non-removable media.

For example, the system memory 244 includes a non-volatile memory 248 such as a hard drive, and may also include a volatile memory 250, such as random access memory (RAM) and/or cache memory. The computer system 240 can further include other removable/non-removable, volatile/non-volatile computer system storage media.

The system memory 244 can include at least one program product having a set (i.e., at least one) of program modules that are configured to carry out functions of the embodiments described herein. For example, the system memory 244 stores various program modules that generally carry out the functions and/or methodologies of embodiments described herein. A module 252 may be included for performing functions related to performing impedance measurements, and a module 254 may be included to perform functions related to control of charging processes. The system 240 is not so limited, as other modules may be included. As used herein, the term “module” refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The processing device 242 can also communicate with one or more external devices 256 as a keyboard, a pointing device, and/or any devices (e.g., network card, modem, etc.) that enable the processing device 242 to communicate with one or more other computing devices. Communication with various devices can occur via Input/Output (I/O) interfaces 264 and 265.

The processing device 242 may also communicate with one or more networks 266 such as a local area network (LAN), a general wide area network (WAN), a bus network and/or a public network (e.g., the Internet) via a network adapter 268. It should be understood that although not shown, other hardware and/or software components may be used in conjunction with the computer system 40. Examples include, but are not limited to: microcode, device drivers, redundant processing units, external disk drive arrays, RAID systems, and data archival storage systems, etc.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this invention belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A system comprising:
a monitoring module configured to determine at least one of a location and a route of a vehicle; and
a recommendation module configured to perform:
identifying a plurality of service stations based on the at least one of the location and the route of the vehicle;
comparing a preference of a first user of the vehicle to preference data related to a second user of another vehicle;
predicting a preferred service station of the plurality of service stations based on the comparing; and
presenting a recommendation to the first user, the recommendation indicating the preferred service station.

2. The system of claim 1, wherein the vehicle is an electric vehicle and the plurality of service stations are a plurality of charging stations.

3. The system of claim 1, wherein the first user and the second user are part of a plurality of users, and the second user is selected from the plurality of users based on a similarity between the second user and the first user.

4. The system of claim 3, wherein the similarity is determined based on comparing an attribute of the first user to an attribute of each of the plurality of users.

5. The system of claim 1, wherein predicting the preferred service station includes assigning a predicted score to at least one of the plurality of service stations.

6. The system of claim 5, wherein the predicted score is determined based on a score matrix for a plurality of users, the plurality of users including the first user and the second user, the score matrix including a score for each combination of a user and an identified service station.

7. The system of claim 6, wherein the similarity is determined based on a first set of latent factors for each user of the plurality of users, and a second set of latent factors for the plurality of service stations, the first set of latent factors and the second set of latent factors estimated based on a machine learning algorithm.

8. The system of claim 7, wherein predicting the preferred service station includes training the machine learning algorithm, generating a user latent factor vector for each user of the plurality of users, generating a service station latent factor vector for each service station of the plurality of service stations, and combining the user latent factor vectors and the service station latent factor vectors.

9. The system of claim 8, wherein predicting the preferred service station includes selecting the second user based on the combining, and assigning a predicted score to the first user based on a score of the second user.

10. A method comprising:
determining at least one of a location and a route of a vehicle;
identifying a plurality of service stations based on the at least one of the location and the route of the vehicle;
comparing a preference of a first user of the vehicle to preference data related to a second user of another vehicle;
predicting a preferred service station of the plurality of service stations based on the comparing; and
presenting a recommendation to the first user, the recommendation indicating the preferred service station.

11. The method of claim 10, wherein the vehicle is an electric vehicle and the plurality of service stations are a plurality of charging stations.

12. The method of claim 10, wherein the first user and the second user are part of a plurality of users, and the second user is selected from the plurality of users based on a similarity between the second user and the first user.

13. The method of claim 12, wherein predicting the preferred service station includes assigning a predicted score to at least one of the plurality of service stations.

14. The method of claim 12, wherein the similarity is determined based on a score matrix for a plurality of users, the plurality of users including the first user and the plurality of second users, the score matrix including a score for each combination of a user and an identified service station.

15. The method of claim 14, wherein the similarity is determined based on a first set of latent factors for each user of the plurality of users, and a second set of latent factors for the plurality of service stations, the first set of latent factors and the second set of latent factors estimated based on a machine learning algorithm.

16. The method of claim 15, wherein predicting the preferred service station includes training the machine learning algorithm, generating a user latent factor vector for each user of the plurality of users, generating a service station latent factor vector for each service station of the plurality of service stations, and combining the user latent factor vectors and the service station latent factor vectors.

17. The method of claim 16, wherein predicting the preferred service station includes selecting the second user based on the combining, and assigning a predicted score to the first user based on a score of the selected second user.

18. A vehicle system comprising:
a memory having computer readable instructions; and
a processing device for executing the computer readable instructions, the computer readable instructions controlling the processing device to perform a method including:
determining at least one of a location and a route of a vehicle;
identifying a plurality of service stations based on the at least one of the location and the route of the vehicle;
comparing a preference of a first user of the vehicle to preference data related to a second user of another vehicle, wherein the first user and the second user are part of a plurality of users;
predicting a preferred service station of the plurality of service stations based on the comparing; and
presenting a recommendation to the first user, the recommendation indicating the preferred service station.

19. The vehicle system of claim 18, wherein the second user is selected from the plurality of users based on a similarity between the second user and the first user.

20. The vehicle system of claim 19, wherein the similarity is determined based on a score matrix for the plurality of users, the score matrix including a score for each combination of a user and an identified service station, and the similarity is determined based on a first set of latent factors for each user of the plurality of users, and a second set of latent factors for the plurality of service stations, the first set of latent factors and the second set of latent factors estimated based on a machine learning algorithm.
